(19) United States
(12) Patent Application Publication
(10) Pub. No.: US 2016/0283070 A1
(43) Pub. Date: Sep. 29, 2016

(54) USING REACTIVE BEHAVIORS DURING REMOTE SESSIONS

(71) Applicant: VMware, Inc., Palo Alto, CA (US)

(72) Inventor: Salim AbiEzzi, Sammamish, WA (US)

(21) Appl. No.: 14/668,776

(22) Filed: Mar. 25, 2015

(51) Int. Cl. G06F 3/0484; G06F 3/14

(52) U.S. Cl. CPC G06F 3/0484; G06F 3/14

(57) ABSTRACT

Systems and techniques are described for remoting application user interfaces. One of the described techniques includes initiating, by a user device, a remote session with a remote application system; during the remote session with the remote application system: receiving, by the user device, reactive behavior data; determining, by the user device, that a particular trigger condition of the one or more trigger conditions has been satisfied; and in response to determining that the particular trigger condition has been satisfied, generating, by the user device, user interface updates by sampling from a user interface function associated with the particular trigger condition and updating a user interface generated by the application being displayed by the user device using the user interface updates.

### BACKGROUND

This document relates to remoting application user interfaces to user devices.

A user of a user device can interact with an application that is executed on a server remote from the user device using a remote display protocol. The remote display protocol can be used to transfer the display data generated by the application for presentation on the user device and to transfer user events generated at the user device to the application. During execution and based on user input events from the user device, the application can generate updates to the display data, and the remote display protocol can be used to transfer the updated display data to the remote client.

### SUMMARY

In general, one aspect of the subject matter described in this document can be embodied in a technique that includes initiating, by a user device, a remote session with a remote application system that allows user interfaces generated by an application executing on the remote application system to be presented on the user device and user events associated with the presented user interfaces to be provided as input to the application; during the remote session with the remote application system: receiving, by the user device, reactive behavior data, wherein the reactive behavior data defines one or more behaviors to be performed by the user device and a respective trigger condition for each of the behaviors, and wherein each behavior is associated with a respective user interface function; determining, by the user device, that a particular trigger condition of the one or more trigger conditions has been satisfied; and in response to determining that the particular trigger condition has been satisfied, generating, by the user device, user interface updates by sampling from a user interface function associated with the particular trigger condition and updating a user interface generated by the application being displayed by the user device using the user interface updates.

For a system of one or more computers to be configured to perform particular operations or actions means that the system has installed on it software, firmware, hardware, or a combination of them that in operation cause the system to perform the operations or actions.

Particular embodiments of the subject matter described in this document can be implemented so as to realize one or more of the following advantages. During a remote session, latency caused by network roundtrips can be minimized. In particular, by allowing a user device to update a presented user interface with user interface data available locally to the device in response to determining that a trigger condition has been satisfied, the wait time between user interface updates can be reduced. The amount of network traffic required to be transmitted during the remote session can also be reduced.

The details of one or more embodiments of the subject matter described in this document are set forth in the accompanying drawings and the description below. Other features, aspects, and advantages of the subject matter will become apparent from the description, the drawings, and the claims.

### BRIEF DESCRIPTION OF THE DRAWINGS

FIG. 1 shows an example remote application system.

FIG. 2 is a flow chart of an example technique for providing reactive behavior data to a user device during a remote session.

FIG. 3 is a flow chart of an example technique for displaying updated user interface data using reactive behavior data during a remote session.

Like reference numbers and designations in the various drawings indicate like elements.

### DETAILED DESCRIPTION

This document generally describes a remote application system that uses reactive behavior data during remote sessions with user devices. During a remote session with a user device, the remote application system can provide reactive behavior data to the user device that includes a reactive behavior and a trigger condition for the reactive behavior. When the user device determines that a trigger condition has been satisfied, the user device can perform the corresponding reactive behavior to update the user interface being presented by the user device without needing to request additional user interface data from the remote application system.

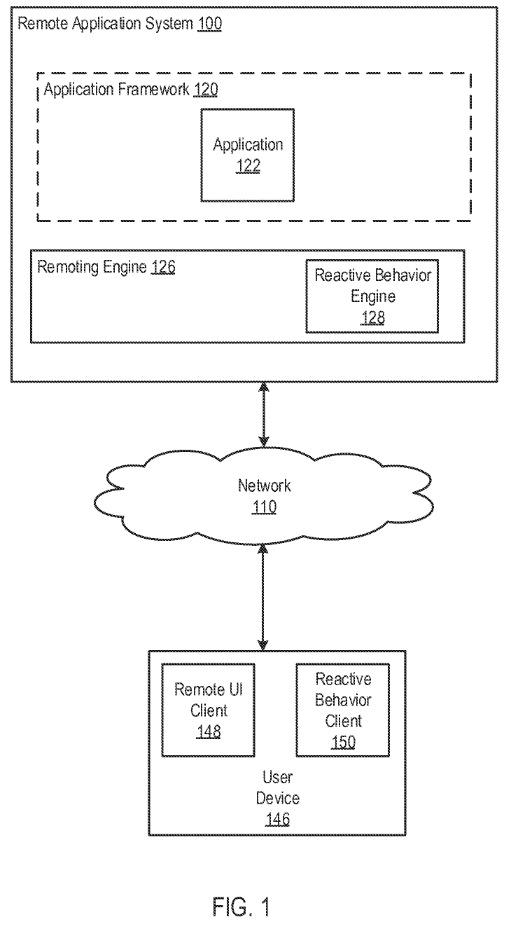

FIG. 1 shows an example remote application system 100. The remote application system 100 is an example of a system implemented as computer programs on one or more computers in one or more locations, in which the systems, components, and techniques described below are implemented.

The remote application system 100 manages the execution of one or more applications and allows users of user devices remote from the remote application system 100 to access and interact with the applications managed by the remote application system 100 by providing user interfaces generated by the applications for presentation on the user devices over a network 110. The network 110 can be, e.g., a local area network (LAN), wide area network (WAN), e.g., the Internet, a cellular data network, or a combination thereof.

In order to allow the users to interact with the application, the remote application system 100 also receives data identifying user events associated with the presented user interfaces and provides those user events as inputs to the applications executing on the remote application system 100. For example, the remote application system 100 can allow a user of a user device 146 to access and interact with an application 122 executing within an application framework 120 on the remote application system 100.

The user device 146 can be any of various user computers that have various display properties and that accept various user input modalities. For example, the user device 146 may be a mobile device, e.g., a smartphone or a tablet computer, a desktop or laptop computer, a network-connected television, and so on.

In some implementations, to account for the different display and input capabilities of different kinds of user devices, the application 122 includes multiple user interface code paths. Each of the user interface code paths, when executed, generates a user interface that is specific to a respective class of user devices. For example, one of the user interface code paths may generate a user interface for user devices that accept touch input, that have displays of specified sizes, and that display output at a specified range of resolutions. As another example, a different one of the user interface code paths may generate a user interface for user devices that accept keyboard and mouse input. As another example, a different one of the user interface code paths may generate a user interface for user devices that accept voice input in addition to touch input. In some other implementations, however, the application 122 includes a single user interface code path that generates the user interface for the application 122.

In order to allow a user of the user device 146 to interact with an application managed by the remote application system 100, the user device 146 includes a remote user interface client 148 that users of the user device 146 can use to interact with the application 122 or with other applications executing on the remote application system 100. In some implementations, the remote user interface client 148 is a special-purpose process executing on the user device 146. In some other implementations, the remote user interface client 148 is a web browser executing on the user device 146.

In particular, a user of one of the user devices 146 can submit a request to the remote application system 100 through the remote user interface client 148 executing on the user device 146 to access the application 122. A remoting engine 126 in the remote application system 100 receives the request from the remote user interface client 148 to access the application 122 and causes the application 122 to generate a user interface. In implementations where the application 122 includes multiple user interface code paths, the remoting engine 126 classifies the user device 146 into a device class and then causes the application 122 to generate a user interface by executing the user interface code path corresponding to the device class. The remoting engine 126 can classify the user device 146 into a device class based on identifying information for the user device 146 received with the request. For example, the identifying information can include the device type of the user device, e.g., mobile phone, tablet, laptop computer, desktop computer, television, and so on, and the input styles accepted by the user device, e.g., touch input, mouse input, keyboard input, infrared (IR) remote, voice input, and so on. As another example, the identifying information can also include information characterizing the display of the user device, e.g., the size of the display, e.g., the x and y dimensions of the display, and the resolution of the display.

The remoting engine 126 then provides the user interface generated by the application 122 to the requesting user device for presentation to the user by the remote user interface client 148 executing on the user device 146. Generally, the remoting engine 126 transmits the user interface data to the remote user interface client 148 executing on the user device 146 using a remote display protocol. In some implementations, the remote display protocol is a pixel-level protocol e.g., the Blast protocol or the remote desktop protocol (RDP), that compresses, encrypts and transports image pixels to the remote user interface client 148 executing on the user device 146. The remote user interface client 148 in turn causes the user device 146 to decrypt, decompress, and display the image pixels. In some other implementations, the remoting engine 126 can provide the user interface data using a higher-level protocol. For example, the higher-level protocol may be a protocol that provides the user interface data using a page layout language with client-side scripting, e.g., a protocol that provides the user interface data in a hypertext markup language (HTML) document with Cascading Style Sheets (CSS) and JavaScript. As another example, the higher-level protocol may be a geometry-based protocol, e.g., a graphics device interface (GDI) protocol.

While the user interface is being displayed to the user, the remote user interface client 148 is configured to detect user events associated with the displayed user interface and provide data identifying the user events to the remoting engine 126. For example, the remote user interface client 148 can detect user events, e.g., a click or touch input on the user interface or a text input or voice command submitted by a user while the user interface is active on the user device, and provide data identifying the user events to the remoting engine 148, e.g., data identifying the location of the user event, the type of the user event, and other user event parameters.

Once the remoting engine 126 receives data identifying a user event, the remoting engine 126 provides the user event as input to the application 122. If the input causes a change to the user interface, the remoting engine 126 receives the updated user interface data from the application 122 and provides the updated user interface data for presentation to the user by the remote user interface client 148, e.g., using the remote display protocol. The continuing exchange of user interface data and data identifying user events between the user device 146 and the remote application system 100 will be referred to in this specification as a “remote session” between the user device 146 and the remote application system 100.

The remote application system 100 may host the application 122 and allow users of the system to interact with the application 122 in any of a variety of ways. For example, the application 122 may be hosted in a virtual machine, on a Remote Desktop Session Host (RDSH) server, or in a container in a web server. As another example, the remote application system 100 may host the application 122 as a software as a service (SaaS) application, i.e., by hosting the application 122 on multiple servers that are fronted by a load balancer, with different instances of the application 122 serving different users.

The remoting engine 126 includes a reactive behavior engine 128. During remote sessions, the reactive behavior engine 128 provides reactive behavior data to a remote behavior client 150 on the user device 146. The remote behavior client 150 can, as described in more detail below, evaluate and render the reactive behavior data into pixel information to be displayed by the remote user interface client 148. Evaluating and rendering the reactive behavior data on the user device 146 allows the remote user interface client 148 to update the presented user interface in response to certain conditions being satisfied without needing to receive updated user interface data from the remote application system 100.

As used in this specification, a behavior is a user interface function that is continuous over time. That is, the user interface function specifies user interface data that should be generated at each time step of a particular time period. Generally, the user interface data is time varying, i.e., the user interface data generated by sampling from the function will be different at each time step of the particular time period. In some cases, the user interface data is predetermined, e.g., an animated image that updates at specified intervals. In some other cases, the user interface data may depend on inputs to the user interface function. For example, a behavior may specify a transition over time between one image and another image in a slideshow, with the user interface data being generated as part of the behavior being dependent on the pixel data of the two images.

A reactive behavior consists of one or more behaviors that are each initiated in response to a respective trigger condition being satisfied. For example, a reactive behavior may be a single behavior associated with a trigger condition, i.e., so that the behavior is performed only when the trigger condition is satisfied. As another example, a reactive behavior may be a set of multiple behaviors that are each associated with a respective trigger condition, i.e., so that if, while one of the behaviors is being performed, the trigger condition for another behavior is satisfied, the other behavior will be performed instead of the initial behavior.

In particular, during a remote session with the remote application system 100 in which the user of the user device 146 is interacting with the application 122, the application 122 may generate reactive behavior data and provide the reactive behavior data to the reactive behavior engine 128. The reactive behavior data includes data that defines one or more behaviors, i.e., one or more user interface functions, and a respective trigger condition for each of the one or more behaviors.

The trigger condition for a given behavior may include time-based trigger conditions, event-based trigger conditions, or both.

A time-based trigger condition is a trigger condition that is satisfied when a certain amount of time elapses from a specified starting time. Optionally, in order for the time-based trigger condition to be satisfied, one or more other criteria must also be met, e.g., criteria for the behavior of the user while the amount of time is elapsing.

For example, when the user interface data being generated by the application 122 is a photo slideshow, the application 122 may provide user interface data identifying a current photo in the slide show and other photos in the slide show. Along with the user interface data, the application 122 may provide reactive behavior data that defines a user interface function for transitioning between photos in the slide show and a time-based trigger condition. The time-based trigger condition may specify that, from the time that the current photo is displayed, a certain number of seconds must elapse in order for the time-based trigger condition to be satisfied and for the transition to the next photo to be performed. Optionally, the time-based trigger condition may also specify that, in order for the condition to be satisfied, the user cannot submit any inputs associated with the displayed user interface before the certain number of seconds elapses. In this example, when the trigger condition is satisfied, the user device 146 samples the user interface function to generate the user interface data necessary to transition to the next photo in the slide show. Thus, when the time-based trigger condition is satisfied, the next photo in the slide show is displayed.

An event-based trigger condition is a trigger condition that is satisfied when a specified user event is received. That, is the event-based trigger condition specifies a user event that must be detected in order for the event-based trigger condition to be satisfied.

In the example where the user interface data being generated by the application 122 is a photo slideshow, an example event-based trigger condition may be that the user event is an input selecting a “next photo” user interface element. In this example, when the event-based trigger condition is satisfied, the user device 146 samples the user interface function to generate the user interface necessary to transition to the next photo even if the time specified by the time-based trigger condition has not yet elapsed.

As another example, where the user interface data being generated by the application 122 and presented on the user device is a portion of an electronic document, an example event-based trigger condition may be that the user event is an input that scrolls the document in a particular direction, e.g., a click on a “scroll up” user interface element, a selection of a designated keyboard key, and so on. In this example, the behavior associated with the event-based trigger condition may be a user interface function that specifies the user interface data to be used to update the user interface as the user drags user interface element or continues to click on the user interface element to scroll the document in the particular direction.

The reactive behavior engine 128 receives the reactive behavior data generated by the application 122 and provides the data to the reactive behavior client 150. Once the reactive behavior data is received, the reactive behavior client 150 can monitor the remote session to determine whether any of the trigger conditions defined in the reactive behavior data have been satisfied and, once a condition has been satisfied, sample the appropriate user interface function to generate user interface data and provide the user interface data to the remote user interface client 148 for use in updating the presented user interface.

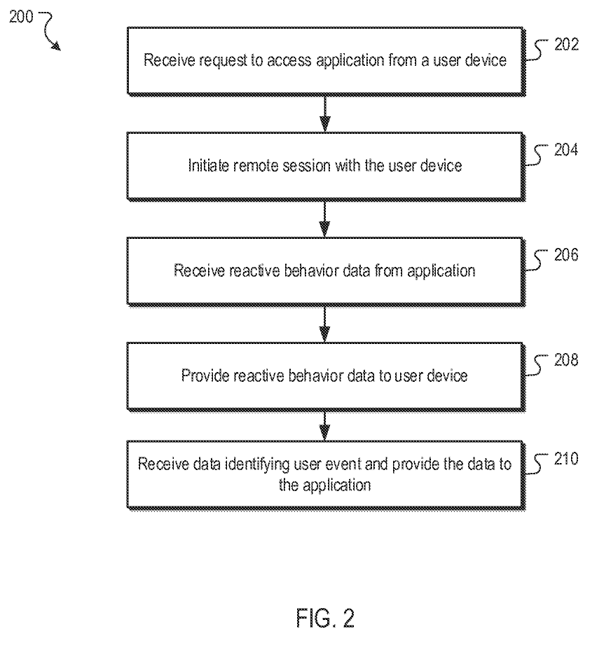

FIG. 2 is a flow chart of an example technique 200 for providing reactive behavior data to a user device during a remote session. The example technique 200 is performed by a system of one or more computers. For example, the technique 200 may be performed by a remote application system, e.g., the remote application system 100 of FIG. 1.

The system receives a request to access an application managed by the system from a user device (step 202). For example, the system can receive the request from a user interface client executing on the user device.

The system initiates a remote session with the user device (step 204). During the remote session, the system provides user interface data generated by the application for presentation on the user device and receives from the user device data identifying user events associated with the presented user interface. The system provides the received user events as input to the application and, if the user events cause a change to the current user interface, receives updated user interface data from the application and provides the updated user interface data for presentation on the user device.

During the remote session, the system receives reactive behavior data from the application (step 206). As described above, the reactive behavior data includes data defining one or more behaviors and, for each of the behaviors, a respective trigger condition.

The system provides the reactive behavior data to the user device (step 208). For example, the system can provide the data to a reactive behavior client that is executing on the user device.

The system receives data from the user device identifying a user event that satisfied a particular trigger condition (step 210). Optionally, the system can also receive data identifying the particular trigger condition that was satisfied by the user event. That is, once the user device determines that the particular trigger condition has been satisfied, the user device sends data identifying the user event and, optionally, data identifying the particular trigger condition to the system so the system can continue to follow the progression of the user interface and manage it accordingly. In implementations where the user device does not send data identifying the particular trigger condition to the system, the system can optionally evaluate received user events to determine whether each user event satisfies the trigger conditions associated with any of the reactive behaviors.

The system provides the data received from the user device to the application (step 212). That is, the system provides data identifying user events and, optionally, satisfied trigger conditions to the application whenever such data is received from the user device. In response, the application may provide additional reactive behavior data to the system, which the system can in turn provide to the user device, e.g., to ensure that unnecessary latency in the user interface is minimized and to reduce network traffic. For example, when the behavior is a transition between two photos in a slideshow, only the two photos need to be transmitted to the user device from the system rather than transmitting the many in-between images that constitute the transition.

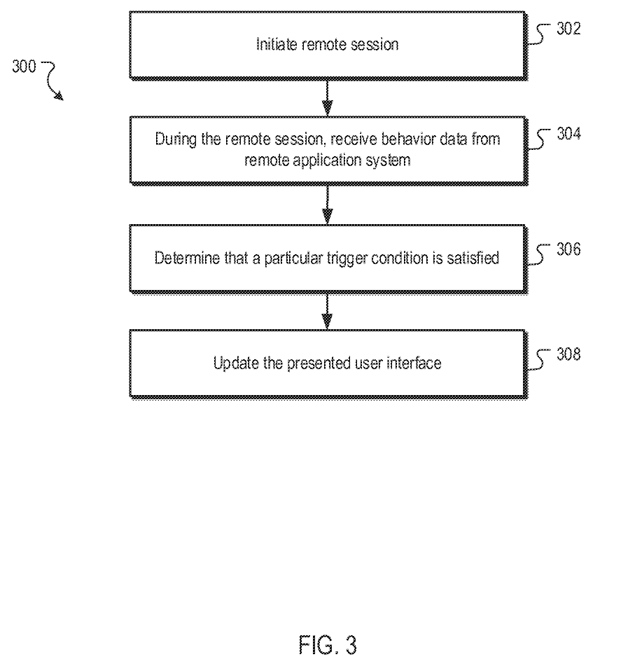

FIG. 3 is a flow diagram of an example process 300 for displaying updated user interface data using reactive behavior data during a remote session. The example technique 300 is performed by a user device, e.g., the user device 146 of FIG. 1, that is in communication with a remote application system, e.g., the remote application system 100 of FIG. 1.

The user device initiates a remote session with a remote application system that allows a user of the user device to interact with an application managed by the remote application system (step 302). In particular, during the remote session, the remote application system provides user interface data generated by the application for presentation on the user device while the user device provides data identifying user events detected by the user device that are associated with the presented user interface to the remote application system.

During the remote session, the user device receives reactive behavior data from the remote application system (step 304). The reactive behavior data includes data defining one or more trigger conditions. The reactive behavior data also includes, for each of the trigger conditions, user interface update data associated with the trigger condition. The user interface update data is data that is to be displayed when the trigger condition is satisfied.

The user device determines that a particular trigger condition has been satisfied (step 306).

For example, if the particular trigger condition is a time-based trigger condition, the user device can determine that the threshold period of time defined by the particular trigger condition has elapsed since the most-recent user event associated with the presented user interface data was detected or since the trigger condition for a different behavior has been satisfied. Optionally, if the time-based condition also defines other criteria for the behavior of the user during the period of time, the user device can also determine that the user's behavior satisfies the other criteria, e.g., by determining that the user has not submitted any user inputs during the period of time.

As another example, if the particular trigger condition is a user event-based trigger condition, the user device can detect a user event associated with the presented user interface and determine that the user event matches the user event identified by the particular trigger condition.

In response to determining that the particular trigger condition has been satisfied, the user device begins performing the behavior associated with the particular trigger condition in order to update the presented user interface (step 308). That is, the user device begins sampling from the user interface function associated with the particular trigger condition in order to generate user interface data to be used to update the presented user interface. Generally, because the behavior is continuous over time, the user interface data generated by sampling the user interface function will change with time and will continue to update until a termination condition is satisfied, e.g., if a specified period of time elapses or a trigger condition for another behavior is satisfied.

In some cases, the user interface data generated by sampling the user interface function changes in a predetermined manner for a specified period of time, i.e., if the user interface function generates user interface data for a predetermined image animation. In some other cases, the user interface data generated by sampling the user interface function may depend on the inputs to the user interface function. For example, if the user interface function generates user interface data for a scrolling mechanism on an electronic document, the user interface data generated will depend on user inputs received while the function is being sampled that scroll the document to particular positions. As another example, if the user interface function defines a transition between two photos in a slideshow, the user interface data generated by function will depend on the pixel data of the current image and the subsequent image in the slideshow.

Once the trigger condition has been satisfied, the user device provides data identifying the user event that satisfied the trigger condition and additional user events that are received while the behavior is being performed to the remote application system. In response, the remote application system may provide additional reactive behavior data to the user device, e.g., in order to download data predictively to avoid the starvation of the reactive behavior client on the user device. Thus, the user device performs reactive behaviors in parallel with transmitting data identifying user events that are detected by the user device to the remote application system.

When the processing of a reactive behavior reaches a steady state, e.g., while both the remote application system and the user device are waiting for the next event to be submitted by the user, the state of the user interface on the remote application system and on the user device are kept synchronized to correctly process future user events. In some implementations, in order to synchronize the user interfaces, when the remote application system determines that a received user event satisfied a particular trigger condition for a particular reactive behavior, the remote application system performs the particular reactive behavior and provides the user interface data generated by performing the behavior to the application for use in updating the application state. In some other implementations, the system provides data identifying the user event and, optionally, data identifying the particular trigger condition to the application and the application or a portion of the application framework performs the particular reactive behavior in order to update the application state. In yet other implementations, once the user device has finished performing the particular reactive behavior, the user device can send the resulting bit map, i.e., the pixel data from the user interface that is displayed after the processing of the reactive behavior has finished, to the remote application system to ensure that the state of the resulting user interface is in sync on the remote application system and on the user device.

Embodiments of the subject matter and the operations described in this document can be implemented in digital electronic circuitry, or in computer software, firmware, or hardware, including the structures disclosed in this document and their structural equivalents, or in combinations of one or more of them. Embodiments of the subject matter described in this document can be implemented as one or more computer programs, i.e., one or more modules of computer program instructions, encoded on computer storage medium for execution by, or to control the operation of, data processing apparatus. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this document can be implemented as operations performed by a data processing apparatus on data stored on one or more computer-readable storage devices or received from other sources. The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this document can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device. e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this document can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this document can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this document, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this document contains many specific implementation details, these should not be construed as limitations on the scope of any inventions or of what may be claimed, but rather as descriptions of features specific to particular embodiments of particular inventions. Certain features that are described in this document in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

1. A method comprising:
initiating, by a user device, a remote session with a remote application system that allows user interfaces generated by an application executing on the remote application system to be presented on the user device and user events associated with the presented user interfaces to be provided as input to the application;
during the remote session with the remote application system:
receiving, by the user device, reactive behavior data, wherein the reactive behavior data defines one or more behaviors to be performed by the user device and a respective trigger condition for each of the behaviors, and wherein each behavior is associated with a respective user interface function;
determining, by the user device, that a particular trigger condition of the one or more trigger conditions has been satisfied; and
in response to determining that the particular trigger condition has been satisfied, generating, by the user device, user interface updates by sampling from a user interface function associated with the particular trigger condition and updating a user interface generated by the application being displayed by the user device using the user interface updates.

2. The method of claim 1, wherein the user interface function associated with the particular trigger condition generates time varying user interface data.

3. The method of claim 1, further comprising:
providing, by the user device, data identifying the particular trigger condition that has been satisfied to the remote application system.

4. The method of claim 3, further comprising:
receiving, by the remote application system, the reactive behavior data from the application;
providing, by the remote application system, the reactive behavior data to the user device;
receiving, by the remote application system, the data identifying the particular trigger condition from the user device; and
providing, by the remote application system, the data identifying the particular trigger condition to the application.

5. The method of claim 1, wherein the particular trigger condition is a time-based trigger condition that is satisfied when a specified amount of time elapses from a specified starting time, and wherein determining that the particular trigger condition has been satisfied comprises determining that the specified amount of time has elapsed from the specified starting time.

6. The method of claim 5, wherein the specified starting time is a time that the user device displayed a specified user interface update.

7. The method of claim 5, wherein determining that the particular trigger condition has been satisfied further comprises determining that user behavior during the specified amount of time satisfies one or more additional criteria defined by the particular trigger condition.

8. The method of claim 1, wherein the particular trigger condition is a user event-based trigger condition that is satisfied when a specified user event is detected, and wherein determining that the particular trigger condition has been satisfied comprises detecting a user event that matches the specified user event.

9. A system comprising a user device, wherein the user device is configured to perform first operations comprising:
initiating a remote session with a remote application system that allows user interfaces generated by an application executing on the remote application system to be presented on the user device and user events associated with the presented user interfaces to be provided as input to the application;
during the remote session with the remote application system:
receiving reactive behavior data, wherein the reactive behavior data defines one or more behaviors to be performed by the user device and a respective trigger condition for each of the behaviors, and wherein each behavior is associated with a respective user interface function;
determining that a particular trigger condition of the one or more trigger conditions has been satisfied; and
in response to determining that the particular trigger condition has been satisfied, generating, by the user device, user interface updates by sampling from a user interface function associated with the particular trigger condition and updating a user interface generated by the application being displayed by the user device using the user interface updates.

10. The system of claim 9, wherein the user interface function associated with the particular trigger condition generates time varying user interface data.

11. The system of claim 9, the first operations further comprising:
providing data identifying the particular trigger condition that has been satisfied to the remote application system.

12. The system of claim 11, further comprising the remote application system, wherein the remote application system is configured to perform operations comprising:
receiving the reactive behavior data from the application;
providing the reactive behavior data to the user device;
receiving the data identifying the particular trigger condition from the user device; and
providing the data identifying the particular trigger condition to the application.

13. The system of claim 9, wherein the particular trigger condition is a time-based trigger condition that is satisfied when a specified amount of time elapses from a specified starting time, and wherein determining that the particular trigger condition has been satisfied comprises determining that the specified amount of time has elapsed from the specified starting time.

14. The system of claim 13, wherein the specified starting time is a time that the user device displayed a specified user interface update.

15. The system of claim 13, wherein determining that the particular trigger condition has been satisfied further comprises determining that user behavior during the specified amount of time satisfies one or more additional criteria defined by the particular trigger condition.

16. The system of claim 9, wherein the particular trigger condition is a user event-based trigger condition that is satisfied when a specified user event is detected, and wherein determining that the particular trigger condition has been satisfied comprises detecting a user event that matches the specified user event.

17. A computer program product encoded on one or more non-transitory computer storage media, the computer program comprising instructions that when executed by one or more computer cause the one or more computers to perform operations comprising:
initiating, by a user device, a remote session with a remote application system that allows user interfaces generated by an application executing on the remote application system to be presented on the user device and user events associated with the presented user interfaces to be provided as input to the application;
during the remote session with the remote application system:
receiving, by the user device, reactive behavior data, wherein the reactive behavior data defines one or more behaviors to be performed by the user device and a respective trigger condition for each of the behaviors, and wherein each behavior is associated with a respective user interface function;
determining, by the user device, that a particular trigger condition of the one or more trigger conditions has been satisfied; and
in response to determining that the particular trigger condition has been satisfied, generating, by the user device, user interface updates by sampling from a user interface function associated with the particular trigger condition and updating a user interface generated by the application being displayed by the user device using the user interface updates.

18. The computer program product of claim 17, wherein the user interface function associated with the particular trigger condition generates time varying user interface data.

19. The computer program product of claim 17, the operations further comprising:
providing, by the user device, data identifying the particular trigger condition that has been satisfied to the remote application system.

20. The computer program product of claim 19, the operations further comprising:
receiving, by the remote application system, the reactive behavior data from the application;
providing, by the remote application system, the reactive behavior data to the user device;
receiving, by the remote application system, the data identifying the particular trigger condition from the user device; and
providing, by the remote application system, the data identifying the particular trigger condition to the application.
